(19) United States
(12) Patent Application Publication
(10) Pub. No.: US 2010/0145869 A1
(43) Pub. Date: Jun. 10, 2010

(54) METHOD FOR CONTROLLING THE MATCHING PROCESS IN AN ONLINE DATING SYSTEM

(76) Inventor: Moses B. Brown, San Diego, CA (US)

Correspondence Address: CHRISTIE, PARKER & HALE, LLP, PO BOX 7068, PASADENA, CA, 91109-7068, US

(21) Appl. No.: 12/624,338

(22) Filed: Nov. 23, 2009

Related U.S. Application Data
(60) Provisional application No. 61/117,914, filed on Nov. 25, 2008.

(51) Int. Cl. G06F 17/30; G06F 15/16; G06Q 30/00

(52) U.S. Cl. 705/319; 707/769; 709/225; 707/758; 707/E17.108

(57) ABSTRACT

A method for controlling the matching process in an online dating system is provided. In one embodiment, the invention relates to a method, performed by a computer for operating a matching service, the method including receiving information identifying preferences for a mate from at least one user, receiving demographic information of the at least one user, the demographic information including a gender of the at least one user, providing first services, when the at least one user is male, for matching the at least one user with a mate, and providing second services, when the at least one user is female, for matching the at least one user with a mate, where the first services are not identical to the second services.

### CROSS-REFERENCE TO PATENT APPLICATIONS

This application claims the benefit of U.S. Provisional Application No. 61/117,914, filed on Nov. 25, 2008, entitled “METHOD FOR CONTROLLING THE MATCHING PROCESS IN AN ONLINE DATING SYSTEM”, the entire content of which is incorporated herein by reference.

### BACKGROUND

The present invention relates to a method for controlling the matching process in an online dating system. More specifically, the invention relates to a method for providing greater control of the matching process to users of a particular gender within an online dating system.

Online dating systems provide a forum for individuals, couples and groups to meet and potentially to develop a romantic or sexual relationship. Typically such systems collect personal information including age, gender, location, physical characteristics and preferences for a potential match. Often online dating systems provide an ability for users to upload photos and search through a database of user profiles. Such systems commonly provide a method for a user to contact a prospective match by a messaging system, such as an email system, or by some other communication system. Some popular online dating systems include Match.com, eHarmony and Yahoo! Personals, each of which are trademarks of their respective business entities. Several patents have been granted to these popular dating websites. For example, eHarmony is the owner of U.S. Pat. No. 6,735,568 entitled “A METHOD AND SYSTEM FOR IDENTIFYING PEOPLE WHO ARE LIKELY TO HAVE A SUCCESSFUL RELATIONSHIP”, the entire content of which is expressly incorporated herein by reference.

Social networking services also provide a meeting place for individuals, couples and groups with a focus on building a wider variety of relationships and online communities. Such services aim to connect users or members who share common interests and activities. Similar to online dating systems, the social networking services generally provide a number of ways for users to communicate, including, for example, email and instant messaging. The social networking services have become extremely popular and almost all of them provide the ability to search through a database of users to find other users having common interests, common activities, or other characteristics of interest. A popular feature of the social networking services includes online dating. Examples of social networking sites include Friendster and MySpace, each of which of are trademarks of their respective business entities. Friendster has been issued U.S. Pat. No. 7,069,308 entitled “A SYSTEM, METHOD AND APPARATUS FOR CONNECTING USERS IN AN ONLINE COMPUTER SYSTEM BASED ON THEIR RELATIONSHIPS WITHIN SOCIAL NETWORKS”, the entire content of which is expressly incorporated herein by reference.

Both online dating systems and social networking systems providing dating services, however, experience problems in matching users of such systems. One reason for matching problems is that the ratio of users based on gender is commonly unbalanced. For example, some of the most popular sites can often have 60 percent male users and 40 percent female users. Another popular dating website has 40 percent male users and 60 percent female users. A number of specialty dating services also exist that cater to special interests such as professionals, sports fans, people with political or religious preferences, and/or people seeking various sexual relationships. For specialty dating websites, the ratio of users can be even more unbalanced. For example, in some cases, it is not uncommon for such dating websites to have 80 percent male users and 20 percent female users.

With gender imbalances, users of the less common gender are more actively sought than their counterparts, have a broad choice of mates, and can thus be more selective in their dating choices. Users of the other gender, the more common gender, however can experience great frustration in the form of repeated rejection based, for example, on unreturned communications. These gender differences create a profound challenge for online dating communities where both male and female users experience such great frustration. Another result of this imbalance is that women receive a disproportionate amount of incoming requests, messages and notifications. Most of these incoming interactions are unwanted and female members must then spend a significant amount of time rejecting them. Conversely, male members waste significant time sending outgoing requests to female members who did not want to receive them in the first place. Accordingly, there is a need for a dating system which accounts for and addresses such gender imbalances.

### SUMMARY OF THE INVENTION

The invention provides a method for controlling the matching process in an online dating system. In one embodiment, the invention relates to a method, performed by a computer for operating a matching service, the method including receiving information identifying preferences for a mate from at least one user, receiving demographic information of the at least one user, the demographic information including a gender of the at least one user, providing first services, when the at least one user is male, for matching the at least one user with a mate, and providing second services, when the at least one user is female, for matching the at least one user with a mate, where the first services are not identical to the second services.

In another embodiment, the invention relates to a method, performed by a computer, for operating a matching service, the method including receiving information identifying preferences for a mate from at least one user, receiving demographic information of the at least one user, the demographic information including a gender of the at least one user, providing, when the at least one user is female, an ability to initiate contact with another user, inhibiting, when the at least one user is male, the male user from contacting a female user unless the female user has authorized contact from the male user.

In yet another embodiment, the invention relates to a method, performed by a computer, for operating a matching service, the method including receiving information identifying preferences for a mate from at least one user, receiving demographic information of the at least one user, the demographic information including a personality trait of the at least one user, providing, when the at least one user has a preselected personality trait, an ability to initiate contact with another user, inhibiting, when the at least one user does not have the preselected personality trait, the user not having the preselected personality trait from contacting an other user unless the other user has authorized such contact.

### BRIEF DESCRIPTION OF THE DRAWINGS

FIG. 1 is a schematic block diagram of a online dating system in accordance with one embodiment of the present invention.

FIG. 2 is flowchart of a process for operating an online dating system that provides unequal services and control of the system based on a user gender in accordance with one embodiment of the present invention.

FIG. 3 is a flowchart of a process for registering users for an online dating system in accordance with one embodiment of the present invention.

FIG. 4 is a flowchart of an overall process for matching users of an online dating system in accordance with one embodiment of the present invention.

FIG. 5 is a flowchart of a process for providing matching services to female users of an online dating system in accordance with one embodiment of the present invention.

FIG. 6 is a screenshot of a home page for a female user in an online dating system in accordance with one embodiment of the present invention.

FIG. 7 is a screenshot of a profile for a female user in an online dating system in accordance with one embodiment of the present invention.

FIGS. 8(a) and 8(b) are a screenshot of a search that can be performed by a female user in an online dating system in accordance with one embodiment of the present invention.

FIG. 9 is a screenshot of search results that can be obtained by a female user in an online dating system in accordance with one embodiment of the present invention.

FIG. 10 is a flowchart of a process for providing matching services to male users of an online dating system in accordance with one embodiment of the present invention.

FIG. 11 is a screenshot of a home page for a male user in an online dating system in accordance with one embodiment of the present invention.

FIG. 12 is a flowchart of a process for providing different matching services for an online dating system based on a user gender in accordance with one embodiment of the present invention.

### DETAILED DESCRIPTION OF THE INVENTION

Referring now to the drawings, embodiments of systems and methods for providing greater control of the matching process to users of a particular gender within an online dating system are illustrated. In some embodiments, the methods provide processes for controlling user permissions that take into account the gender imbalances in dating systems by treating users of different genders differently. Traditional online dating communities are often designed and developed without different protocols for different genders and therefore provide a unisex user experience. In several embodiments, the methods described herein enable female members to initiate contact with another member while preventing male members from initiating contact with other members. The effect is a new digital environment that provides a dating community driven by a Sadie Hawkins or ladies' choice model.

In some embodiments, the profiles of female users are hidden until the female users choose to make them viewable for particular male users of their choice. In such case, the dating system provides female users with extra security and privacy not found in conventional online dating systems where, for example, profiles of female users are available to the viewing public. In a number of embodiments, only female users have the ability to perform a search of the profiles of users of the opposite gender. As a result of these features, embodiments of the current invention enable female users to be highly selective in deciding with who they would like to communicate. In addition, the matching process can be more efficient than conventional online dating systems. In most embodiments, male users and female users expend less time during the matching process while achieving more productive results. In some embodiments, the invention includes a billing system that bills users in a different manner based on gender.

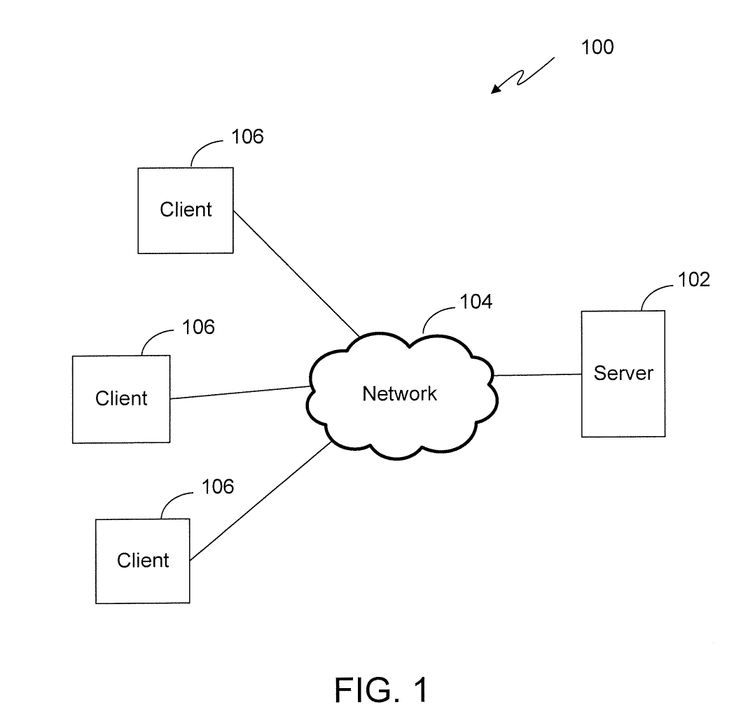

FIG. 1 is a schematic block diagram of a online dating system in accordance with one embodiment of the present invention. The online dating system 100 includes a server 102 coupled to a network 104 which is coupled to three client computers 106. In a number of embodiments, the network 104 is the Internet. In several embodiments, the server 102 is a website server and the client computers 106 are client computers configured to run web based applications. In such case, the client computers can provide an Internet browser application enabling user access of a dating website provided on the server 102. In some embodiments, methods for providing unequal control of the matching process for online dating systems are executed on both the server and the client computers. In other embodiments, the methods are executed either on the server or on the client computers.

In the illustrated embodiment, the system includes one server. In other embodiments, the system can include more than one server (e.g., a group of servers). In the illustrated embodiment, the system includes three clients. In other embodiments, the system includes more than or less than three client computers. In some embodiments, the network can be a private network or another network suitable for providing online dating services.

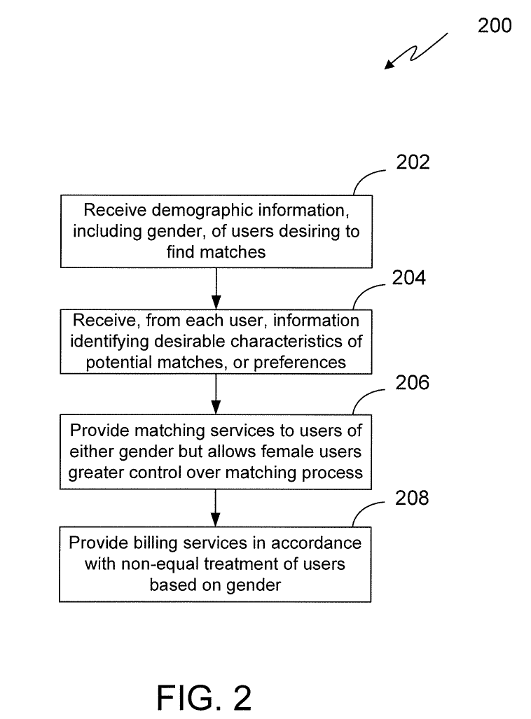

FIG. 2 is flowchart of a process 200 for operating an online dating system that provides unequal services and control of the system based on a user gender in accordance with one embodiment of the present invention. In particular embodiments, the process 200 is performed by the server and client computers via the network of FIG. 1. The process first receives (202) demographic information, including gender information, of users desiring to find matches. In one embodiment, the demographic information further includes information such as age, weight, height, hair color, eye color, occupation, marital status, and other information characteristic of a user. In some embodiments, the process receives information relating to the activities, interests and other personal characteristics of a user. The process then receives (204), from each user, information identifying desirable characteristics of potential matches, or user preferences. In one embodiment, such characteristics include an age range, a particular physical characteristic, an occupation or other characteristic that is stored in a database maintained by the dating system. In a number of embodiments, the demographic information and the user preferences of each user are stored in a user profile within the database.

The process then provides (206) matching services to users of either gender but allows female users to have greater control over the matching process than male users. In one embodiment, for example, a male user cannot view a profile of a female user unless the female user has expressed interest in the male user. In some embodiments, a female user can search through or browse a database containing profiles of male users. In such case, however, a male user cannot search the database of female users, unless each female user in the database has granted him access by invitation. The process also provides (208) billing services in accordance with the non-equal services and control of the matching process based on gender. In one embodiment, for example, female users are offered a monthly subscription rate for the dating service and provided an ability to contact an unlimited number of users. In another embodiment, male users are offered credit-based subscriptions and use individual credits when accepting/responding to female requests, allowing male members to pay for only those connections that they are actually interested in.

In one embodiment, the process can perform the illustrated actions in any order. In another embodiment, the process can omit one or more of the actions. In some embodiments, the process performs additional actions in conjunction with the process. In other embodiments, one or more of the actions are performed simultaneously.

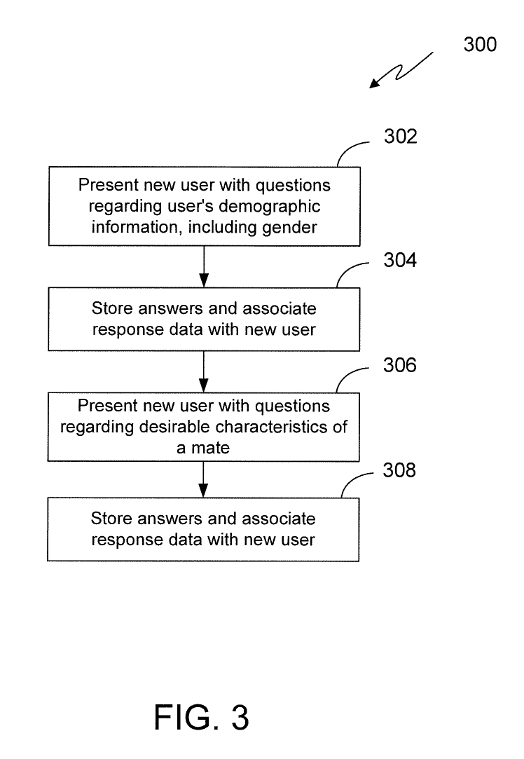

FIG. 3 is a flowchart of a process 300 for registering users for an online dating system in accordance with one embodiment of the present invention. In particular embodiments, the process 300 is performed by the server and client computers via the network of FIG. 1. The process presents (302) a new user with questions regarding demographic information of the user, including gender. In one embodiment, the demographic information further includes information such as age, weight, height, hair color, eye color, occupation, marital status, and other such information. The process stores (304) the answers and associates the answers or response data with the new user in a user database. In a number of embodiments, the response data is associated with a new user by reference to a unique username chosen by the new user.

The process presents (306) the new user with questions regarding desirable characteristics of a mate. In some embodiments, such characteristics include an age range, a particular physical characteristic, an occupation or other characteristic that is stored by the dating system. The process stores (308) the answers and associates the answers or response data with the new user in a user database. In a number of embodiments, the demographic information and the user preferences of each user are stored in a user profile referenced by a unique username. In other embodiments, billing options are presented to the user based on the gender of the user. In some embodiments, information necessary to contact a user is collected, including, for example, an email address.

In one embodiment, the process can perform the illustrated actions in any order. In another embodiment, the process can omit one or more of the actions. In some embodiments, the process performs additional actions in conjunction with the process. In other embodiments, one of more of the actions are performed simultaneously.

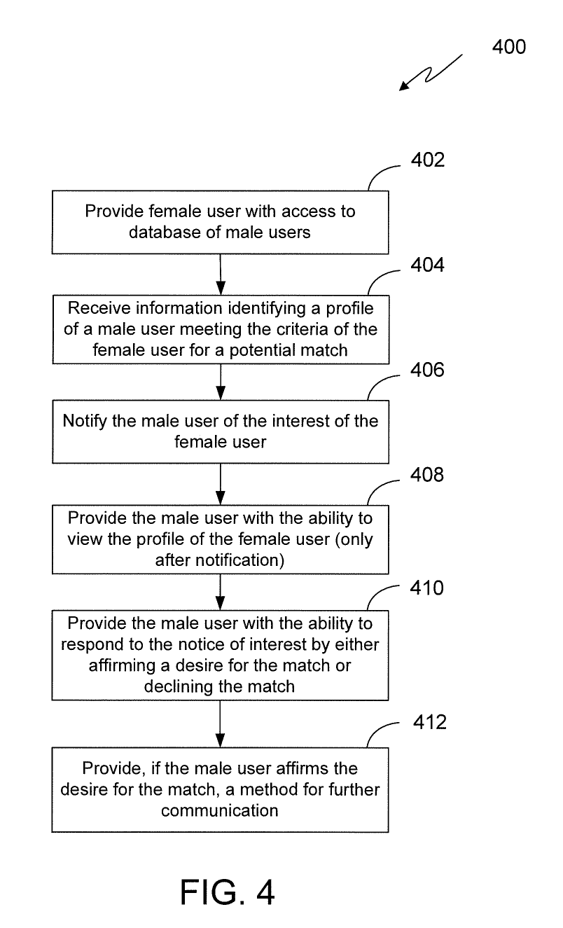

FIG. 4 is a flowchart of an overall process 400 for matching users of an online dating system in accordance with one embodiment of the present invention. In particular embodiments, the process 400 is performed by the server and client computers via the network of FIG. 1. The process provides (402) a female user with access to a database of male users. In a number of embodiments, the female user is provided search tools enabling searches by particular categories such as age or other characteristics defined in the profiles of male users. In other embodiments, female users can perform key word searches. The process then receives (404) information from the female user identifying a profile of a male user meeting her criteria for a potential mate. In some embodiments, the female user also specifies one of a number of ways to initiate communication with a male user (e.g., electronic wink, nudge, flirt, message, etc.).

The process notifies (406) the male user of the interest of the female user. In some embodiments, the process sends the male user an email indicating the interest of the female user. In other embodiments, other forms of notification can be used. The process provides (408) the male user with the ability to view the profile of the female user, but only after receiving her notification/permission. In many embodiments, a male user can only view the profile of a female user after the female user has provided her permission to the male user. In many embodiments, male users have no ability to search the database of female users. The process provides (410) the male user with the ability to respond to the notice of interest by either affirming a desire for the match or declining the match. The process provides (412), if the male user affirms the desire for the match, a method for further communication. In one embodiment, the method for further communication includes an email system or another messaging system.

In the embodiment illustrated in FIG. 4, a female user has greater control and choice in the matching process than a male user. In other embodiments, a male user is provided greater control and choice in the matching process than a female user.

In one embodiment, the process can perform the illustrated actions in any order. In another embodiment, the process can omit one or more of the actions. In some embodiments, the process performs additional actions in conjunction with the process. In other embodiments, one of more of the actions are performed simultaneously.

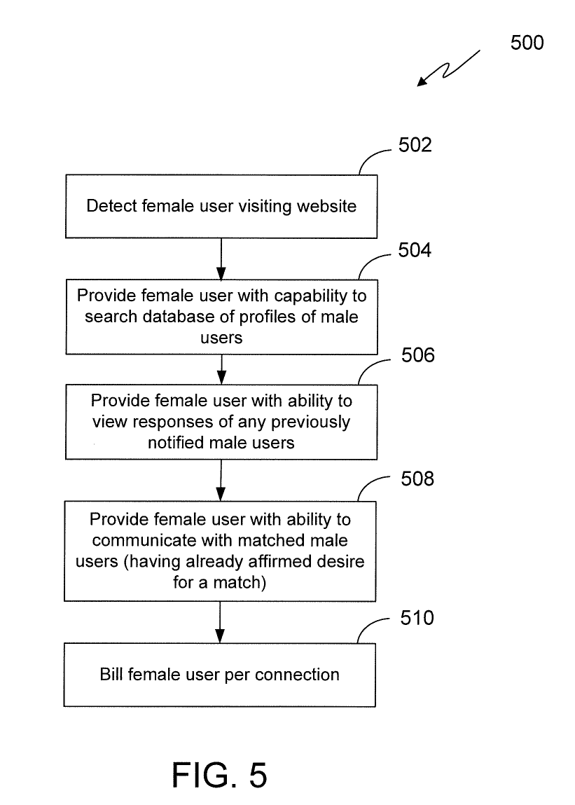

FIG. 5 is a flowchart of a process 500 for providing matching services to female users of an online dating system in accordance with one embodiment of the present invention. In particular embodiments, the process 500 is performed by the server and/or client computers via the network of FIG. 1. The process first detects (502) a female user visiting website. In a number of embodiments, the female user is returning to the website after already having completed a new user registration process, and is presented with a home page providing content tailored to the female user. In some embodiments, detection occurs when the female user logs into the dating system with a username that is linked to a pre-existing profile for the female user. The process then provides (504) the female user with the capability to search a database of profiles for male users. In a number of embodiments, the female user is presented with searching tools enabling searches by a particular category such as age or other characteristics defined in the profiles of male users. In other embodiments, female users can perform key word searches.

The process provides (506) the female user with the ability to view any responses of previously notified male users. In some embodiments, the responses take the form of an email or another form of electronic messaging. The process then provides (508) the female user with the ability to communicate with matched male users that have already confirmed their desire for a match with the female user. In one embodiment, the ability to communicate is provided using an email system or another messaging system. The process can then bill (510) the female user per connection. In such case, the service fee is dependent on the number of members she contacts in a particular billing period (e.g., one month). In some embodiments, the billing period is more than or less than one month. In other embodiments, the female user pays a flat monthly service fee no matter how many members she contacts. In other embodiments, other billing methods can be used.

In one embodiment, the process can perform the illustrated actions in any order. In another embodiment, the process can omit one or more of the actions. In some embodiments, the process performs additional actions in conjunction with the process. In other embodiments, one of more of the actions are performed simultaneously.

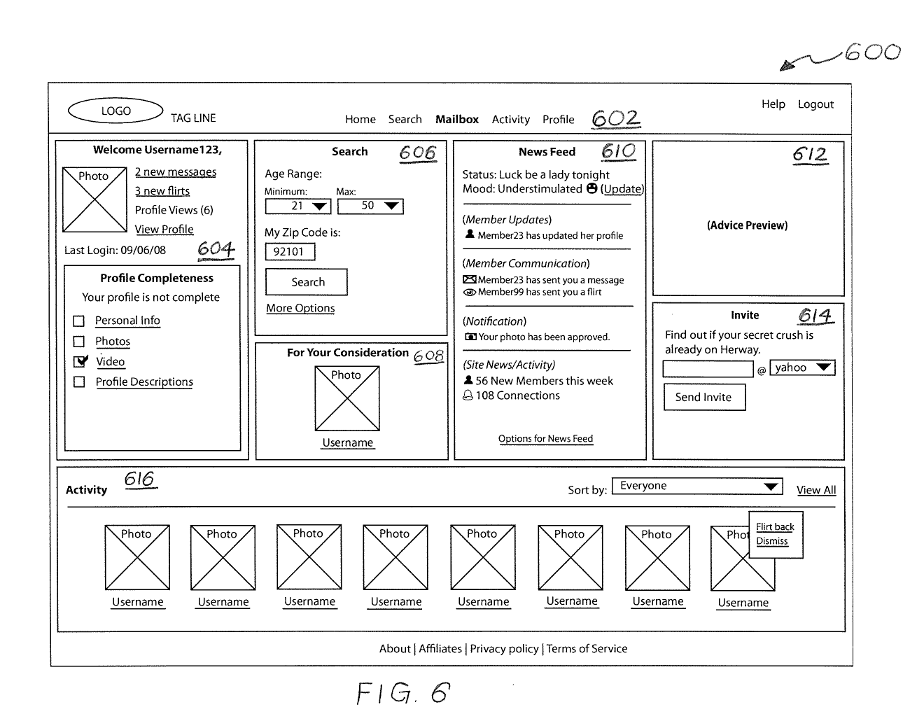

FIG. 6 is a screenshot of a home page 600 for a female user in an online dating system in accordance with one embodiment of the present invention. The home page 600 includes a navigation toolbar 602 at the top providing links to the “Home” page, a “Search” page, a “Mailbox” page, an “Activity” page, a “Profile” page, and links to “Help” and “Logout”. The home page 600 further includes an identity and status module 604, a quick search module 606, a suggested match module 608, a newsfeed module 610, an advice module 612, an invitation module 614, and a activity highlights module 616.

From the navigation toolbar 602, a female user can search a database of male users by clicking on “Search” link, check electronic mail messages by clicking on the “Mailbox” link, check the activity or hits associated with her own home page by clicking on the “Activity” link, or view and edit her own profile by clicking on the “Profile” link.

The identity and status module 604 can provide information regarding the status of the profile and recent activity such as messages, flirts, profile views and last login information. The quick search module 606 can allow a search of the database of male users based on a reduced set of criteria, including, for example, age and location. The suggested match module 608 can present a potential match based on preferences set up during initial registration, matching algorithms, and/or past search preferences. The newsfeed module 610 can provide information regarding the number of members in the online dating system, new members, new connections between members, member communications, and/or other news of interest. The advice module 612 can provide tips or suggestions for establishing connections with other users and finding a match that suits the female user. The invitation module 614 can enable a female user to see if a particular desirable male has already joined the online dating system, or, alternatively to invite non-members to join the online dating system. The activity module 616 can display the profile names and pictures of male users with which the female user has already established some form of communication. In some instances, the female user can choose to “flirt back” or “dismiss” a particular male user within the activity module.

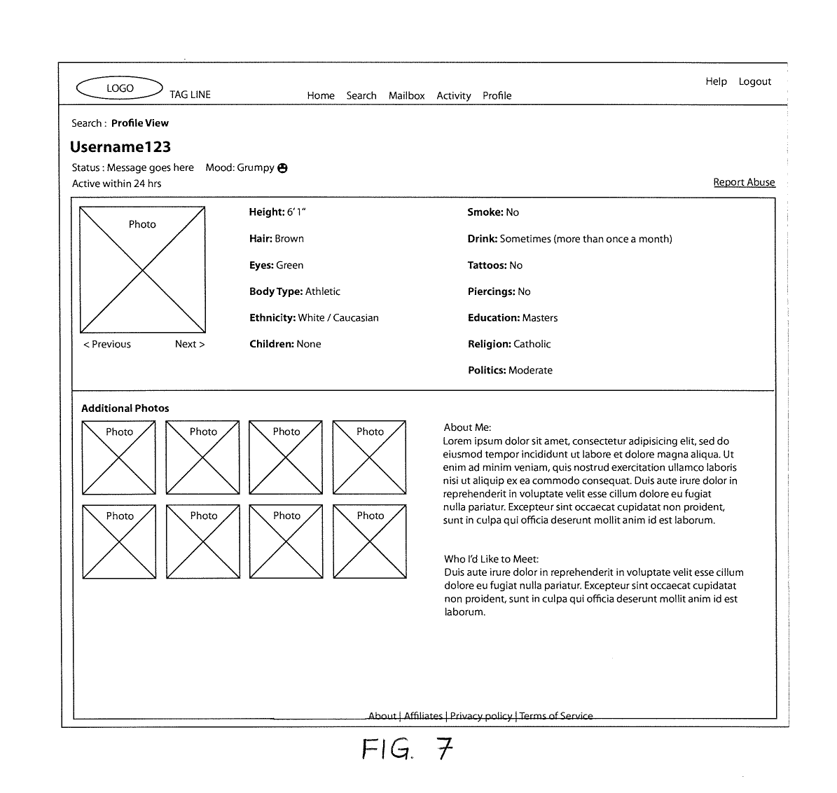

FIG. 7 is a screenshot of a profile for a female user in an online dating system in accordance with one embodiment of the present invention. In the embodiment illustrated in FIG. 7, the profile for the female user includes, a username, a mood, a primary photo, demographic information, additional photos, some background information in an “About Me” section, and information regarding the characteristics of a potential mate in a “Who I′d Like to Meet” section. In other embodiments, the profile for the female user can include other information.

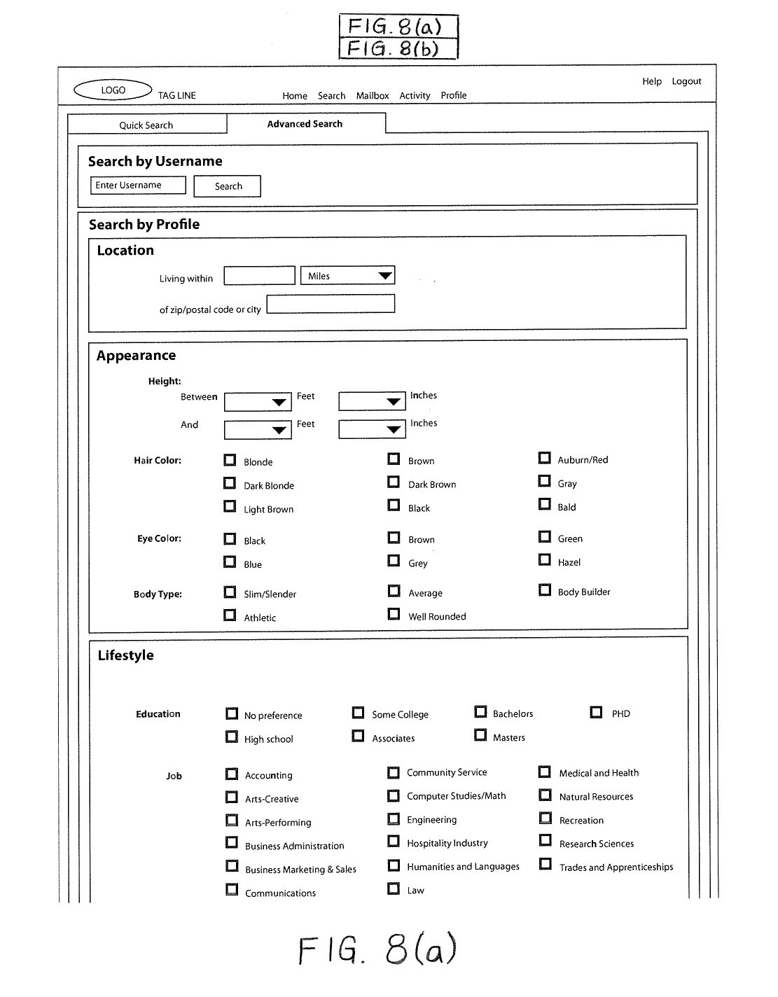

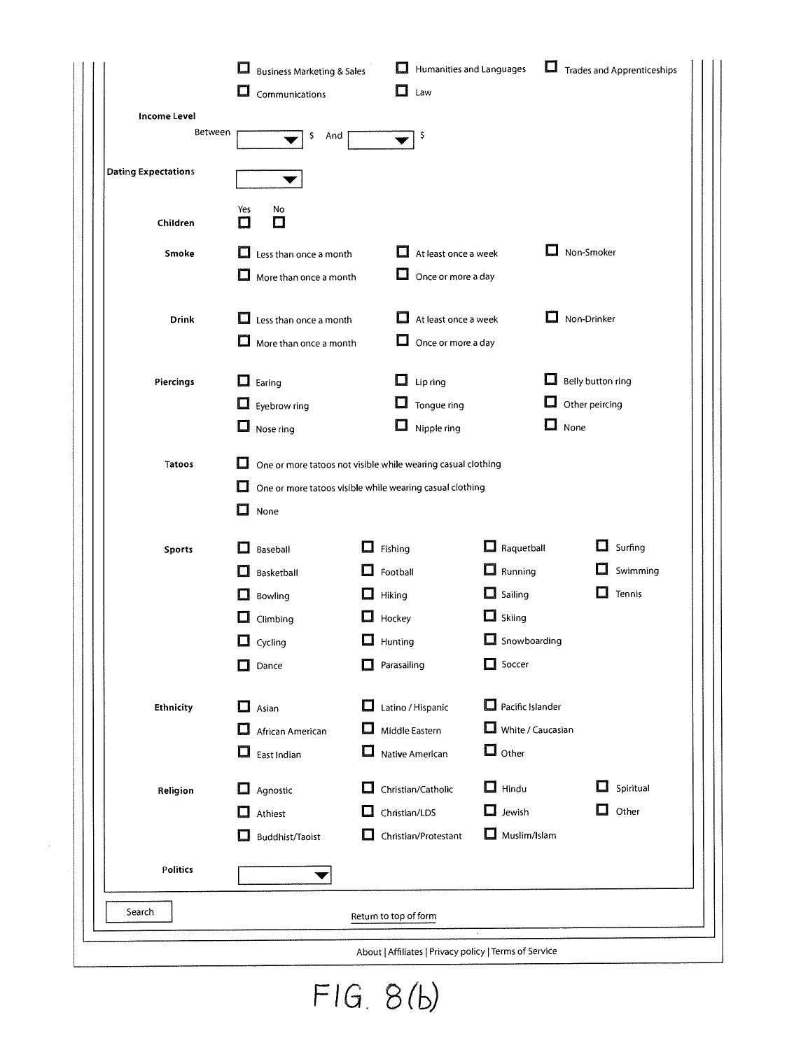

FIGS. 8(a) and 8(b) are a screenshot of a search that can be performed by a female user in an online dating system in accordance with one embodiment of the present invention. A female user can perform an advanced search, as depicted in FIGS. 8(a) and 8(b), based on characteristics of male users including location, appearance, and lifestyle, where each of the search criteria can include a number of sub-categories. In other embodiments, other categories and search criteria can be used.

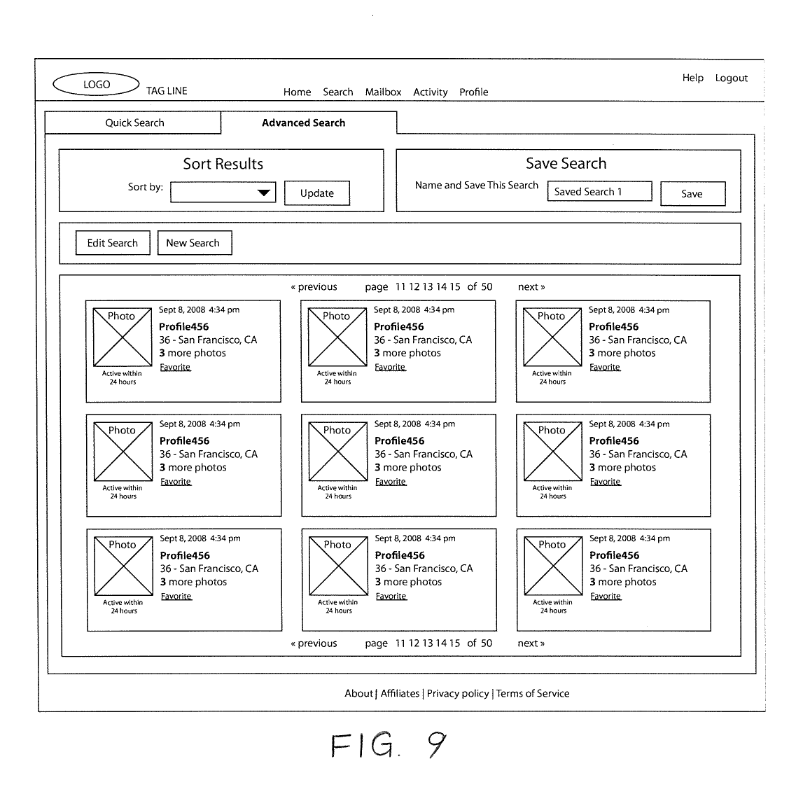

FIG. 9 is a screenshot of search results that can be obtained by a female user in an online dating system in accordance with one embodiment of the present invention. The search results include the profiles of a number of male users meeting the criteria of the search established by the female user. By clicking on a profile, the female user can be presented with a number of options for initiating communication with a desirable male user.

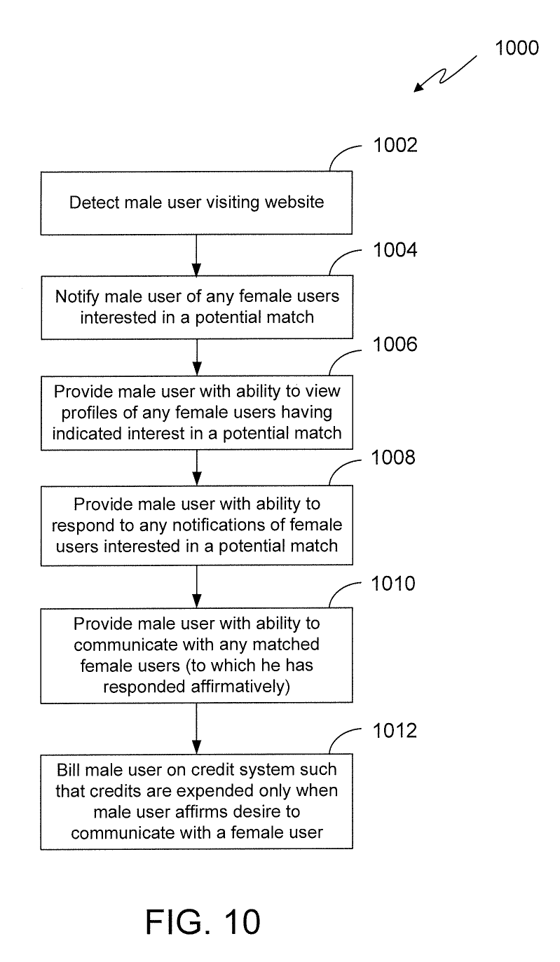

FIG. 10 is a flowchart of a process 1000 for providing matching services to male users of an online dating system in accordance with one embodiment of the present invention. In some embodiments, the process 1000 is performed by the server and client computers via the network of FIG. 1. The process first detects (1002) a male user visiting website. In a number of embodiments, the male user is returning after already having completed a new user registration process. In some embodiments, detection occurs when the male user logs into the dating system by providing a username that is linked to a pre-existing profile for the male user. The process then notifies (1004) the male user of any female users interested in a potential match. In a number of embodiments, the notification can take different forms. The process then provides (1006) the male user with the ability to view the profiles of any female users having indicated an interest in a potential match. In several embodiments, the viewable profiles of female users include only those profiles that have been made available to the male user by the respective female users.

The process provides (1008) the male user with the ability to respond to any notifications from female users interested in a potential match. In a number of embodiments, these notifications have only recently been delivered to the male user by the dating system. The process then provides (1010) the male user with the ability to communicate with any matched female users, where the matched female users include those users to which he has already affirmatively responded in favor of communication. In one embodiment, the ability to communicate is provided using an email system or another messaging system. The process bills (1012) the male user on a credit system where credits are expended only when the male user affirms his desire to communicate with a female user. In one embodiment, such a billing system ensures that a male user only pays for the connections with female users that he is actually interested in. In other embodiments, the male user can be billed in other ways.

In one embodiment, the process can perform the illustrated actions in any order. In another embodiment, the process can omit one or more of the actions. In some embodiments, the process performs additional actions in conjunction with the process. In other embodiments, one of more of the actions are performed simultaneously.

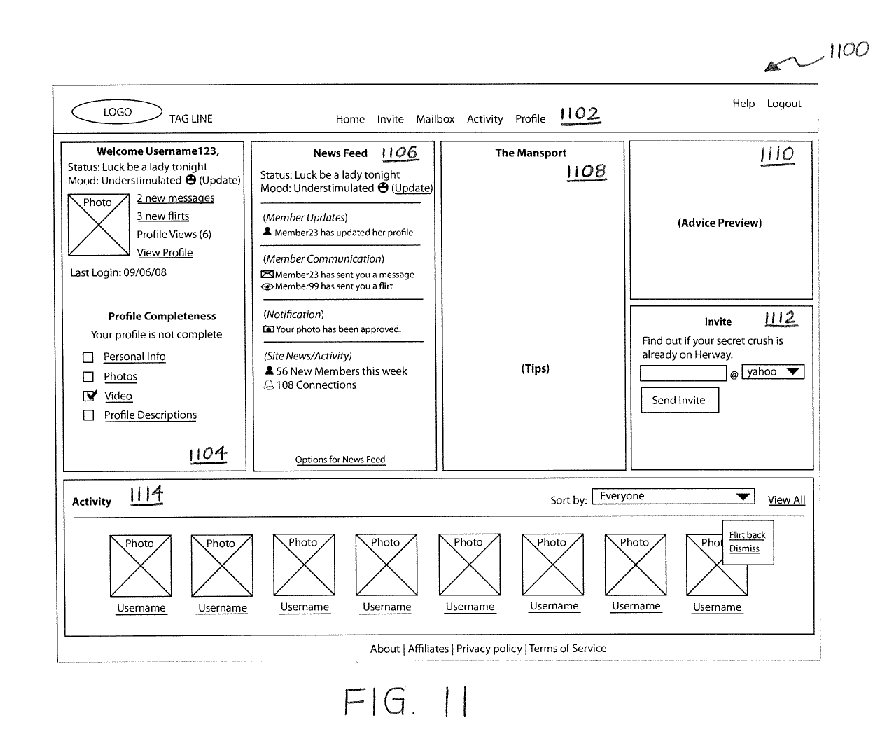

FIG. 11 is a screenshot of a home page 1100 for a male user in an online dating system in accordance with one embodiment of the present invention. The home page 1100 includes a navigation toolbar 1102 at the top providing links to the “Home” page, an “Invite” page, a “Mailbox” page, an “Activity” page, a “Profile” page, and links to “Help” and “Logout”. The home page 1100 further includes an identity and status module 1104, a newsfeed module 1106, a male interactive content section 1108, an advice module 1110, an invitation module 1112, and a activity highlights module 1114.

From the navigation toolbar 1102, a male user can invite new users by clicking on “Invite” link, check electronic mail messages by clicking on the “Mailbox” link, check the activity or hits associated with his own home page by clicking on the “Activity” link, or view and edit his own profile by clicking on the “Profile” link. In the embodiment illustrated in FIG. 11, note that the home page for the male user does not include a search capability.

The identity and status module 1104 can provide information regarding the status of the profile and recent activity such as messages, flirts, profile views and last login information. The newsfeed module 1106 can provide information regarding the number of members in the online dating system, new members, new connections between members, member communications, and/or other news of interest. The male interactive content section 1108 can provide game scores, facts, video and other content appreciated by an average male user. In the embodiment illustrated in FIG. 11, the male interactive content section 1108 effectively provides alternative activities for male users as they cannot search and must wait for women to initiate contact.

The advice module 1110 can provide tips or suggestions for establishing connections with other users and for finding a match that suits the male user. The invitation module 1112 can enable a male user to see if a particular desirable female has already joined the online dating system, or, alternatively to invite non-members to join the online dating system. The activity module 1114 can display the profile names and pictures of female users with which the male user has already established some form of communication. In some instances, the male user can choose to “flirt back” or “dismiss” a particular female user within the activity module.

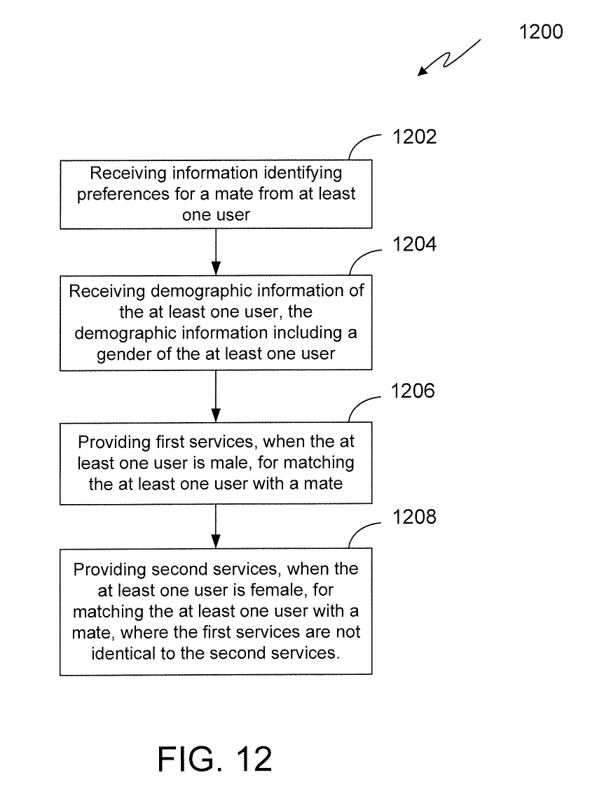

FIG. 12 is a flowchart of a process 1200 for providing different matching services for an online dating system based on a gender of the user in accordance with one embodiment of the present invention. In some embodiments, the process 1200 is performed by the server and client computers via the network of FIG. 1. The process first receives (1202) information identifying preferences for a mate from a user. The process then receives (1204) demographic information of the user, the demographic information including a user gender. The process provides (1206) first services, when the user is male, for matching the user with a mate. In one embodiment, the first services include an ability to respond to notifications of interest from female users, an ability to view the profiles of female users that have indicated interest in the male user, and an ability to communicate with female users that have indicated interest in the male user. In other embodiments, the first services include other services useful for establishing a connection with female users.

The process provides (1208) second services, when the user is female, for matching the user with a mate, where the first services are not identical to the second services. In one embodiment, the second services include the ability to search a database of profiles of male users, the ability to view the responses of male users to prior notifications of interest from the female user, and the ability to communicate with male users that have confirmed a desire for a match. In other embodiments, the second services include other services useful for establishing a connection with male users.

In one embodiment, the process can perform the illustrated actions in any order. In another embodiment, the process can omit one or more of the actions. In some embodiments, the process performs additional actions in conjunction with the process. In other embodiments, one of more of the actions are performed simultaneously.

In some embodiments, the online dating system includes a billing system that bills users in different ways based on gender. In one embodiment, for example, male users are billed using a credit system such that male users use their credits only when accepting invitations for communication, or notifications, from female users. In this way, male users pay only for the connections that they are actually interested in pursuing. In some embodiments, female users are billed based on a periodic subscription fee allowing for an unlimited number of connection requests or notifications made to male users. In such case, female users are encouraged to contact as many male users as they would like without concern for service fees. In other embodiments, the female users are billed just for the connections they establish like the male users.

In one embodiment, greater control of the matching process is provided to male users rather than female users. In various embodiments, greater control of the matching process can be provided to users based on characteristics other than gender. In some embodiments, greater control of the matching process for particular users can be used with dating systems that provide matching services for non-heterosexual users. In one such embodiment, greater control of the matching process can be provided to those users identifying themselves as typically dominant in a relationship. In another embodiment, greater control of the matching process can be provided to those users identifying themselves as typically submissive in a relationship. In other embodiments, greater control in the matching process can be provided to certain users based upon other criteria for classifying users in an online dating system.

In some embodiments, the online dating system includes a performance feedback feature (e.g., profile performance) for male users of the system. The performance feedback feature can provide performance information on statistics associated with a male user's profile. In one embodiment, for example, the feature provides information on the number of times the male user's profile appeared in a search result for female users (e.g., impressions). The feature can also provide information on the click-through rate for the male user's profile, where the click through rate is indicative of the percentage of female users who saw the male user's profile in a search result and then clicked on his profile to learn more about the male user. The click through rate can be expressed as the total number of clicks to view the male user's profile divided by the number of impressions.

In another embodiment, the performance feedback feature can also provide information on the “conversion rate”, or the number of times female users have furthered the matching process by deciding to initiate contact with the male user (e.g., a conversation established after the female user would have clicked through to learn more about the male user and how to make contact with him). In some embodiments, the “conversion rate” can be a measure of the success of a male user's profile's and the general success of the male user in the matching process. In a number of embodiments, the performance data can be displayed in charts illustrating the performance of the particular male user over time and/or versus a typical or average male user (e.g., “average Joe”). In such case, the online dating system and matching process can be enhanced by providing feedback on aspects of a male user's profile. The male user can experiment by changing different components of his profile, such as pictures, descriptions of the male user and related characteristics. In this way, the male user can continuously work to improve his profile. In addition, the performance feedback feature can provide an outlet for a male user's natural desire to compete with others.

While the above description contains many specific embodiments of the invention, these should not be construed as limitations on the scope of the invention, but rather as specific examples thereof. Accordingly, the scope of the invention should be determined not by the embodiments illustrated, but by the appended claims and their equivalents.

What is claimed is:

1. A method, performed by a computer, for operating a matching service, the method comprising:
receiving information identifying preferences for a mate from at least one user;
receiving demographic information of the at least one user, the demographic information comprising a gender of the at least one user;
providing first services, when the at least one user is male, for matching the at least one user with a mate; and
providing second services, when the at least one user is female, for matching the at least one user with a mate;
wherein the first services are not identical to the second services.

2. The method of claim 1:
wherein the second services comprise providing the at least one female user with an ability to initiate contact with another user;
wherein first services do not include, for the at least one male user, an ability to initiate contact with another user.

3. The method of claim 1, further comprising:
generating a profile for the at least one user based on the information identifying preferences and the demographic information;
wherein the providing first services comprises inhibiting a male user from viewing a profile of a female user unless the female user has initiated contact with the male user.

4. The method of claim 3, further comprising:
providing an ability for a female user to view profiles of male users.

5. The method of claim 1, further comprising:
generating a profile for the at least one user based on the information identifying preferences and the demographic information;
wherein the providing first services comprises preventing a male user from viewing a profile of a female user unless the female user has authorized contact with the male user.

6. The method of claim 1, further comprising:
generating a profile for the at least one user based on the information identifying preferences and the demographic information; and
providing, to a female user, an ability to search profiles of male users.

7. The method of claim 1, further comprising:
generating a profile for the at least one user based on the information identifying preferences and the demographic information; and
providing, only to a female user, an ability to search profiles of male users.

8. The method of claim 1, further comprising:
generating a profile for the at least one user based on the information identifying preferences and the demographic information; and
providing, to a male user, an ability to respond to a notification of interest from a female user.

9. The method of claim 1, further comprising:
generating a profile for the at least one user based on the information identifying preferences and the demographic information; and
providing, to a male user, an ability to communicate with a female user having sent a notification of interest to the male user.

10. The method of claim 9, further comprising:
providing, to the female user, an ability to communicate with any male users having affirmatively responded to a notice of interest from the female user.

11. The method of claim 1, further comprising:
billing, when the at least one user is female, a flat rate subscription fee on a periodic basis.

12. The method of claim 1, further comprising:
billing, when the at least one user is male, the male user using a credit system where the male user uses credits only for those connections the male user chooses to make.

13. The method of claim 1, further comprising:
billing, when the at least one user is female, the female user using a credit system where the female user uses credits only for those connections the female user chooses to make.

14. The method of claim 1:
wherein the first services comprise providing the at least one male user with an ability to initiate contact with another user;
wherein second services do not include, for the at least one female user, an ability to initiate contact with another user.

15. The method of claim 1, further comprising:
generating a profile for the at least one user based on the information identifying preferences and the demographic information;
wherein the providing second services comprises preventing a female user from viewing a profile of a male user unless the male user has initiated contact with the female user.

16. The method of claim 1, wherein the first services comprise providing the at least one male user with feedback information indicative of a performance of a profile of the at least one male user.

17. The method of claim 16, wherein the feedback information includes information selected from a group consisting of a number of impressions, a click-through rate, and a conversion rate.

18. A method, performed by a computer, for operating a matching service, the method comprising:
receiving information identifying preferences for a mate from at least one user;
receiving demographic information of the at least one user, the demographic information comprising a gender of the at least one user;
providing, when the at least one user is female, an ability to initiate contact with another user;
inhibiting, when the at least one user is male, the male user from contacting a female user unless the female user has authorized contact from the male user.

19. The method of claim 18, further comprising:
generating a profile for the at least one user based on the information identifying preferences and the demographic information; and
providing, only to a female user, an ability to search profiles of male users.

20. A method, performed by a computer, for operating a matching service, the method comprising:
receiving information identifying preferences for a mate from at least one user;
receiving demographic information of the at least one user, the demographic information comprising a personality trait of the at least one user;
providing, when the at least one user has a preselected personality trait, an ability to initiate contact with another user;
inhibiting, when the at least one user does not have the preselected personality trait, the user not having the preselected personality trait from contacting an other user unless the other user has authorized such contact.

21. The method of claim 20, wherein the preselected personality trait is selected from a group consisting of a dominant personality and a submissive personality.
